(19) United States
(12) Patent Application Publication
(10) Pub. No.: US 2021/0078227 A1
(43) Pub. Date: Mar. 18, 2021

(54) CONTROL DEVICE AND CONTROL METHOD FOR INJECTION MOLDING MACHINE

(71) Applicant: FANUC CORPORATION, Minamitsuru-gun (JP)

(72) Inventor: Atsushi Horiuchi, Minamitsuru-gun (JP)

(21) Appl. No.: 17/018,057

(22) Filed: Sep. 11, 2020

(30) Foreign Application Priority Data
Sep. 18, 2019 (JP) 2019-169567

(51) Int. Cl. B29C 45/50; B29C 45/62; B29C 45/60; B29C 45/46; B29C 45/77; B29C 45/74

(52) U.S. Cl. CPC B29C 45/50; B29C 45/62; B29C 45/74; B29C 45/461; B29C 45/77; B29C 45/60

(57) ABSTRACT

A control device for an injection molding machine that performs a metering of a resin while the resin is being melted inside a cylinder, includes a pressure acquisition unit that acquires a pressure of the resin, a reverse rotation control unit that causes a screw to be rotated in reverse so as to reduce the pressure of the resin, after the screw has been moved rearward to a predetermined metering position, a judgment unit that judges whether or not the pressure of the resin has reached a predetermined rearward movement initiation pressure, after the reverse rotation of the screw is started, and a rearward movement control unit which causes the screw to be moved rearward, in the case it is judged that the pressure of the resin has reached the rearward movement initiation pressure.

### CROSS-REFERENCE TO RELATED APPLICATION

This application is based upon and claims the benefit of priority from Japanese Patent Application No. 2019-169567 filed on Sep. 18, 2019, the contents of which are incorporated herein by reference.

### BACKGROUND OF THE INVENTION

### Field of the Invention

The present invention relates to a control device and a control method for an injection molding machine.

### Description of the Related Art

In relation to an injection molding machine, several methods have been proposed for reducing variations in the product quality of molded products. For example, in Japanese Laid-Open Patent Publication No. 09-029794, in relation to an injection device (injection unit), it has been proposed to perform sucking back of a screw, and reverse rotation of the screw sequentially after metering of a resin. According to the disclosure, and in accordance with such actions, variations in weight of the resin inside the cylinder are reduced.

### SUMMARY OF THE INVENTION

Such a method of sequentially performing suck back and reverse rotation of the screw is not preferable from the standpoint of obtaining molded products efficiently on a timewise basis.

Thus, the present invention has the object of providing a control device and a control method for an injection molding machine, which are capable of quickly achieving a reduction in pressure, and enable high quality molded products to be obtained.

One aspect of the present invention is characterized by a control device for an injection molding machine including a cylinder into which a resin is supplied, and a screw configured to move forward and rearward and rotate inside the cylinder, the injection molding machine being configured to perform a metering of the resin while the resin is being melted inside the cylinder, by causing the screw to be moved rearward to a predetermined metering position while being forwardly rotated, the control device including a pressure acquisition unit configured to acquire a pressure of the resin inside the cylinder, a reverse rotation control unit configured to cause the screw to be rotated in reverse based on a predetermined reverse rotation condition so as to reduce the pressure of the resin, after the screw has been moved rearward to the predetermined metering position, a judgment unit configured to judge whether or not the pressure of the resin has reached a predetermined rearward movement initiation pressure, after the reverse rotation of the screw is started, and a rearward movement control unit configured to cause the screw to be moved rearward based on a predetermined rearward movement condition, in the case that the judgment unit judges that the pressure of the resin has reached the rearward movement initiation pressure.

Another aspect of the present invention is characterized by a method of controlling an injection molding machine including a cylinder into which a resin is supplied, and a screw configured to move forward and rearward and rotate inside the cylinder, the injection molding machine being configured to perform a metering of the resin while the resin is being melted inside the cylinder, by causing the screw to be moved rearward to a predetermined metering position while being forwardly rotated, the method including a reverse rotation control step of causing the screw to be rotated in reverse based on a predetermined reverse rotation condition so as to reduce a pressure of the resin, while monitoring the pressure of the resin inside the cylinder, after the screw has been moved rearward to the predetermined metering position, a judgment step of judging whether or not the pressure of the resin has reached a predetermined rearward movement initiation pressure, after the reverse rotation of the screw is started, and a rearward movement control step of moving the screw rearward based on a predetermined rearward movement condition and rotating the screw in reverse, so as to reduce the pressure of the resin, in the case that it is judged in the judgment step that the pressure of the resin has reached the rearward movement initiation pressure.

According to the present invention, a control device and a control method for an injection molding machine are provided, which are capable of quickly achieving a reduction in pressure, and in which high quality molded products can be obtained.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a side view of an injection molding machine according to an embodiment of the present invention;

FIG. 2 is a schematic cross-sectional view of an injection unit according to the embodiment;

FIG. 3 is a schematic configuration diagram of a control device;

FIG. 4 is an example of a table that is referred to by a judgment unit according to the embodiment;

FIG. 5 is a flowchart showing an example of a method of controlling the injection molding machine, which is executed by a control device of the embodiment;

FIG. 6 is a time chart of a rotational speed of a screw in the case that the control method of FIG. 5 is performed;

FIG. 7 is a time chart of a rearward movement speed of the screw in the case that the control method of FIG. 5 is performed; and

FIG. 8 is a time chart of a back pressure applied to a resin inside a cylinder in the case that the control method of FIG. 5 is performed.

### DESCRIPTION OF THE PREFERRED EMBODIMENTS

Preferred embodiments of a control device and a control method for an injection molding machine according to the present invention will be presented and described in detail below with reference to the accompanying drawings. It should be noted that each of the directions discussed below conform to the arrows shown in the respective drawings.

### EMBODIMENTS

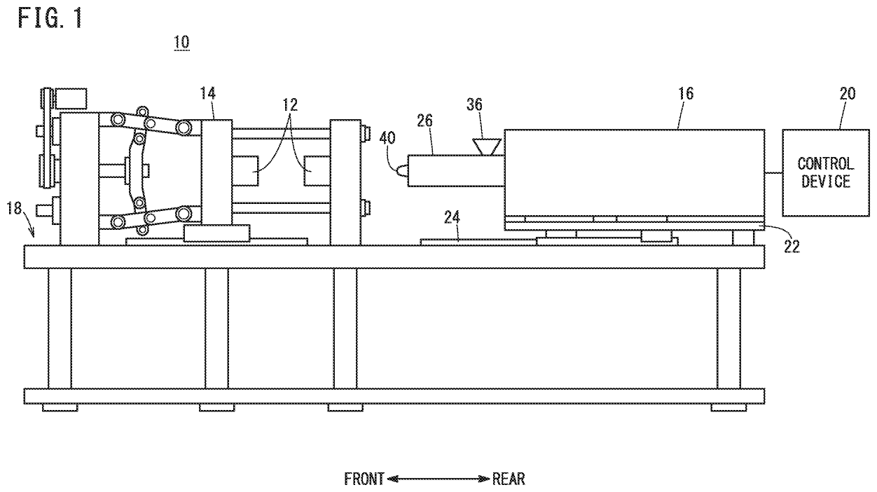

FIG. 1 is a side view of an injection molding machine 10 according to an embodiment of the present invention.

The injection molding machine 10 according to the present embodiment comprises a mold clamping unit 14 having a mold 12 that is capable of being opened and closed, an injection unit 16 that faces toward the mold clamping unit 14 in a front-rear direction, a machine base 18 on which such components are supported, and a control device 20 that controls the injection unit 16.

Among such components, the mold clamping unit 14 and the machine base 18 can be configured based on a known technique. Accordingly, in the following discussion, descriptions of the mold clamping unit 14 and the machine base 18 will be appropriately omitted.

Prior to describing the control device 20 of the present embodiment, at first, a description will be given concerning the injection unit 16, which is a control target of the control device 20.

The injection unit 16 is supported by a base 22, and the base 22 is supported by a guide rail 24 which is installed on the machine base 18 so as to be capable of moving forward and backward. Consequently, the injection unit 16 is capable of moving forward and backward on the machine base 18, and can both come into contact with and separate away from the mold clamping unit 14.

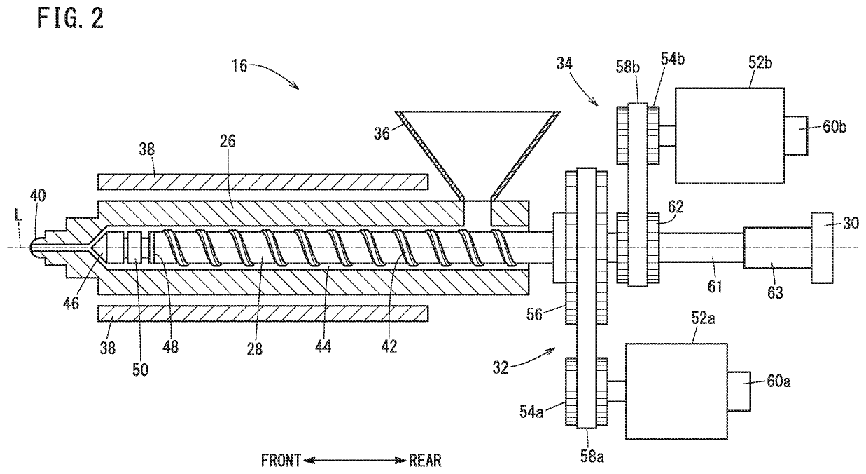

FIG. 2 is a schematic cross-sectional view of the injection unit 16.

The injection unit 16 is equipped with a tubular shaped heating cylinder (cylinder) 26, a screw 28 provided inside the cylinder 26, a pressure sensor 30 provided on the screw 28, and a first drive device 32 and a second drive device 34 connected to the screw 28.

The axial lines of the cylinder 26 and the screw 28 coincide with each other on an imaginary line L according to the present embodiment. Such a system may also be referred to as an “in-line (in-line screw) system”. Further, an injection molding machine to which such an in-line system is applied may also be referred to as an “in-line injection molding machine”.

As advantages of such an in-line injection molding machine, there may be cited, for example, a point in which the structure of the injection unit 16 is simpler, and a point in which the maintainability thereof is excellent, as compared with other types of injection molding machines. In this instance, as another type of injection molding machine, for example, a preplasticating type injection molding machine is known.

As shown in FIG. 2, the cylinder 26 includes a hopper 36 provided on a rear side, a heater 38 for heating the cylinder 26, and a nozzle 40 provided on a front-side end thereof. Among such elements, the hopper 36 is provided with a supply port for supplying a molding material resin to the cylinder 26. Further, an injection port for injecting the resin into the cylinder 26 is provided on the nozzle 40.

The screw 28 includes a spiral flight part 42 provided to span across the longitudinal (front-rear) direction thereof. The flight part 42, together with an inner wall of the cylinder 26, constitutes a spiral flow path 44. The spiral flow path 44 guides in a frontward direction the resin that is supplied from the hopper 36 into the cylinder 26.

The screw 28 includes a screw head 46 which is on a distal end on the front side, a check seat 48 that is disposed at a certain distance in a rearward direction from the screw head 46, and a check ring (a ring for backflow-prevention) 50 that is capable of moving between the screw head 46 and the check seat 48.

The check ring 50 moves in a frontward direction relative to the screw 28 when the check ring receives a forward pressure from the resin located on a rear side of the check ring 50 itself. Further, upon receiving a rearward pressure from the resin on the front side thereof, the check ring 50 moves in a rearward direction relative to the screw 28.

At a time of metering (to be described later), the resin which is supplied from the hopper 36 to the supply port of the cylinder 26 is fed and compressed in the frontward direction while being melted along the flow path 44 by the forward rotation of the screw 28, and the pressure on a more rearward side than the check ring 50 becomes larger. When this occurs, the check ring 50 moves in the frontward direction, and the flow path 44 is gradually opened accompanying such movement. Consequently, the resin becomes capable of flowing toward the front side beyond the check seat 48 along the flow path 44.

Conversely, at a time of injection, the pressure on the front side becomes greater than the pressure on the rear side of the check ring 50. When this occurs, the check ring 50 moves in the rearward direction relative to the screw 28, and the flow path 44 is gradually closed accompanying such movement. When the check ring 50 is moved rearward until being seated on the check seat 48, a state is brought about in which it is maximally difficult for the resin to flow forward and rearward of the check ring 50, and a situation is prevented in which the resin on a more frontward side than the check seat 48 flows in reverse to a more rearward side than the check seat 48.

The pressure sensor 30, such as a load cell or the like for sequentially detecting the pressure imposed on the resin inside the cylinder 26, is attached to the screw 28. According to the present embodiment, the above-described “pressure imposed on the resin inside the cylinder 26” may also be referred to simply as a “back pressure” or alternatively a “pressure of a resin (resin pressure)”.

The first drive device 32 serves to rotate the screw 28 inside the cylinder 26. The first drive device 32 includes a servomotor 52a, a drive pulley 54a, a driven pulley 56, and a belt member 58a. The drive pulley 54a rotates integrally with a rotary shaft of the servomotor 52a. The driven pulley 56 is disposed integrally on the screw 28. The belt member 58a transmits the rotational force of the servomotor 52a from the drive pulley 54a to the driven pulley 56.

When the rotary shaft of the servomotor 52a rotates, the rotational force of the servomotor 52a is transmitted to the screw 28 via the drive pulley 54a, the belt member 58a, and the driven pulley 56. Consequently, the screw 28 rotates.

In this manner, by causing the rotary shaft of the servomotor 52a to rotate, the first drive device 32 serves to rotate the screw 28. Moreover, by changing the direction in which the rotary shaft of the servomotor 52a is rotated, in response to the changing, the direction of rotation of the screw 28 can be switched between forward rotation and reverse rotation.

A position/speed sensor 60a is provided on the servomotor 52a. The position/speed sensor 60a detects the rotational position and the rotational speed of the rotary shaft of the servomotor 52a. The detection result therefrom is output to the control device 20. Consequently, the control device 20 is capable of calculating the rotation amount, the rotational acceleration, and the rotational speed of the screw 28, based on the rotational position and the rotational speed detected by the position/speed sensor 60a.

The second drive device 34 serves to move the screw 28 forward and rearward (which may be also referred to as “backward” in this specification) inside the cylinder 26. The second drive device 34 includes a servomotor 52b, a drive pulley 54b, a belt member 58b, a ball screw 61, a driven pulley 62, and a nut 63. The drive pulley 54b rotates integrally with a rotary shaft of the servomotor 52b. The belt member 58b transmits the rotational force of the servomotor 52b from the drive pulley 54b to the driven pulley 62. An axial line of the ball screw 61 and an axial line of the screw 28 coincide with each other on the imaginary line L. The nut 63 is screw-engaged with the ball screw 61.

When a rotational force is transmitted from the belt member 58b, the ball screw 61 converts the rotational force into linear motion, and transmits the linear motion to the screw 28. Consequently, the screw 28 is moved forward and rearward.

In this manner, by causing the rotary shaft of the servomotor 52b to rotate, the second drive device 34 serves to move the screw 28 forward and rearward. Moreover, by changing the direction in which the rotary shaft of the servomotor 52b is rotated, in response to the changing, the movement direction of the screw 28 can be switched between forward movement (advancing) and rearward movement (retracting).

Further, a position/speed sensor 60b which is similar to the position/speed sensor 60a is provided on the servomotor 52b. As the position/speed sensor 60b, there may be used the same type of sensor as the position/speed sensor 60a described above, however the present invention is not limited to this feature. Consequently, the control device 20 is capable of calculating the forward and rearward positions of the screw 28 in the front-rear direction, as well as the forward and rearward movement speeds of the screw 28, based on the rotational position and rotational speed detected by the position/speed sensor 60b.

In the above-described injection unit 16, when the screw 28 is forwardly rotated while introducing the resin into the cylinder 26 through the hopper 36, the resin is gradually fed and compressed in the frontward direction along the flow path 44.

During such a time, the resin is melted (plasticized) by being subjected to heating by the heater 38 and due to the rotational force of the screw 28. The molten resin accumulates in a region on the front side of the check seat 48 within the region inside the cylinder 26. Hereinafter, the region on the front side of the check seat 48 inside the cylinder 26 may also be referred to as a “metering region”.

The forward rotation of the screw 28 is initiated from a state in which the screw 28 has been fully advanced inside the cylinder 26 (a state in which the volume of the metering region is at a minimum), and is performed until the screw 28 has been moved rearward to a predetermined position (metering position). Further, the rearward movement of the screw 28 is performed so as to maintain the back pressure in the vicinity of a predetermined value (metering pressure) P1. This series of steps may also be referred to as “metering (metering step)”.

By determining the position of the screw 28 at the metering position by moving the screw 28 rearward while controlling the forward and rearward movement of the screw 28 so as to maintain the back pressure during metering in the vicinity of the metering pressure P1, it is possible to keep the volume of the metering region and the density of the resin substantially constant each time that the metering is performed.

However, inertia is generated in the servomotor 52a that causes the screw 28 to rotate, and the drive pulley 54a, the belt member 58a, and the driven pulley 56, which transmit the rotational force of the servomotor 52a. Accordingly, even if the rotation of the screw 28 is made to stop, the screw 28 cannot be stopped instantaneously due to the influence of such inertia. For this reason, a time lag occurs during a period from the screw 28 having reached the metering position and until the forward rotation of the screw 28 comes to a stop. During such a time lag as well, the resin is continuously fed and compressed from the rearward direction toward the frontward direction. Furthermore, after the forward rotation of the screw 28 is stopped as well, due to the influence of viscous resistance of the molten resin, the flow of the resin from the rearward direction toward the frontward direction is not stopped instantaneously, and the resin continues to be fed and compressed for a while.

Due to the above factors, in most cases, the amount of resin accumulated in the metering region is actually greater than an amount (appropriate amount) of the resin required for satisfactory molding. This causes a molding failure in which the masses of the manufactured molded products vary. However, as will be described later, in accordance with the control device 20 of the present embodiment, even if a larger amount of resin than the appropriate amount is accumulated in the metering region, it is possible to easily achieve uniformity in the masses of the molded products.

After the screw 28 has reached the metering position, the screw 28 is reversely rotated or the screw 28 is moved rearward (sucked back) in order to reduce the back pressure. This series of steps may also be referred to as “pressure reduction (pressure reducing step)”. It is desirable that such a reduction in pressure be continued until the back pressure is reduced in close proximity to zero (target pressure P0).

However, if the reduction in pressure is excessive, air is drawn in from the nozzle 40 into the interior of the cylinder 26, and air bubbles become mixed in the resin inside the cylinder 26. An excessive reduction in pressure in this case signifies, for example, that the amount of reduction in pressure (rotation amount, rearward movement position) due to reverse rotation or being sucked back is excessive, or the vigorousness of the reduction in pressure (rotational speed, rearward movement speed) is excessive. When the injection and mold clamping described below are performed using a resin with air bubbles mixed therein, a variation occurs in the masses of the molded products obtained by injection. This becomes a primary cause of poor appearance and poor product quality.

Conversely, if the reduction in pressure is insufficient, a molding failure referred to as drooling (leakage) occurs, in which molten resin leaks from the tip end of the nozzle 40. Accordingly, ideally, the reduction in pressure is executed so as to prevent drooling, while also preventing air bubbles from becoming mixed into the resin that is accumulated inside the cylinder 26. Moreover, according to the control device 20 of the present embodiment, as will be described later, such an ideal reduction in pressure can be easily achieved.

After the metering step and the subsequent pressure reducing step, the resin accumulated in the metering region inside the cylinder 26 is filled into a cavity inside the mold 12. Such a step may also be referred to as “injection (injection step)”. In the injection step, the screw 28 is advanced on the side of the injection unit 16, while a mold clamping force is applied to the closed mold 12 on the side of the mold clamping unit 14. At this time, the mold 12 and the nozzle 40 are pressed into contact (placed in a nozzle touching) state. As a result, the molten resin is injected from the tip end of the nozzle 40 into the mold 12. After having carried out the injection step, the mold clamping unit 14 performs a step referred to as “mold opening (mold opening step)” to open the mold 12. Consequently, the resin that is filled in the cavity inside the mold 12 is taken out from the mold 12 as a molded product. Following the mold opening step, a step referred to as “mold closing (mold closing step)” is performed in which the mold 12 included in the mold clamping unit 14 is closed in preparation for a subsequent molding.

The combination of the plurality of steps executed by the injection molding machine 10 in order to produce the molded product may also be referred to as a “molding cycle”. Any of the aforementioned metering step, the pressure reducing step, the injection step, the mold opening step, and the mold closing step is a step that can be included in the molding cycle. By repeatedly executing the molding cycle, the injection molding machine 10 is capable of mass producing molded products.

The control device 20 serves to execute at least the pressure reducing step from among the plurality of steps included in the molding cycle. A description will be given below concerning the configuration of the control device 20 of the present embodiment.

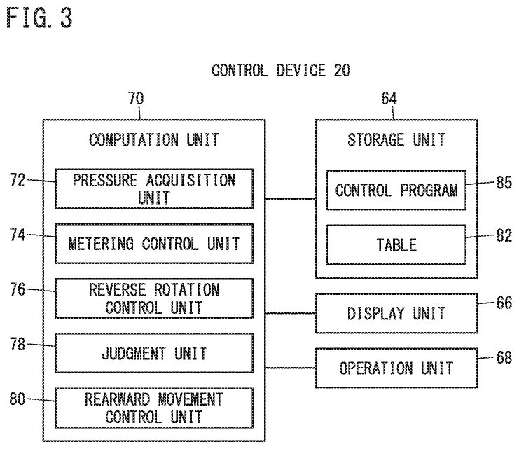

FIG. 3 is a schematic configuration diagram of the control device 20.

As illustrated in FIG. 3, the control device 20 is equipped with a storage unit 64, a display unit 66, an operation unit 68, and a computation unit 70 as a hardware configuration. The computation unit 70 may be configured by a processor such as a CPU (Central Processing Unit) or the like, however the present invention is not limited to this feature. The storage unit 64 includes a volatile memory and a nonvolatile memory, neither of which are shown. Examples of the volatile memory include a RAM or the like. Examples of the nonvolatile memory include a ROM, a flash memory, or the like.

A predetermined control program 85 for controlling the injection unit 16 is stored in advance in the storage unit 64, and apart therefrom, information is stored in the storage unit 64 as needed during execution of the control program 85.

The display unit 66, although not particularly limited, is a display device including, for example, a liquid crystal screen, and appropriately displays information in relation to the control process performed by the control device 20.

The operation unit 68, although not particularly limited, includes, for example, a keyboard, a mouse, or a touch panel that is attached to the screen of the display unit 66, and is used by an operator in order to transmit commands to the control device 20.

As illustrated in FIG. 3, the computation unit 70 includes a pressure acquisition unit 72, a metering control unit 74, a reverse rotation control unit 76, a judgment unit 78, and a rearward movement control unit 80. These units are realized by the computation unit 70 executing the aforementioned control program 85 in cooperation with the storage unit 64.

The pressure acquisition unit 72 sequentially acquires the back pressure detected by the pressure sensor 30. The acquired back pressure is stored in the storage unit 64. At this time, the acquired back pressure is stored in the storage unit 64, for example, in the form of time series data.

The metering control unit 74 performs the aforementioned metering based on predetermined metering conditions (hereinafter, also simply referred to as “metering conditions”). A forward rotational speed (metering rotational speed) of the screw 28 during metering, and the metering pressure P1 are defined as such metering conditions. The metering control unit 74 may refer to the metering conditions that are stored in advance in the storage unit 64, or may follow along with metering conditions that are instructed (specified) by the operator via the operation unit 68.

The metering control unit 74 controls the first drive device 32 and causes the screw 28 to be forwardly rotated at the metering rotational speed until the screw 28 arrives at the metering position, and in addition, controls the second drive device 34 in a manner so that the back pressure becomes the metering pressure P1, and thereby adjusts the rearward movement speed and the position of the screw 28. During this period, the metering control unit 74 performs the control while appropriately referring to the back pressure acquired by the pressure acquisition unit 72. When the screw 28 is moved rearward to the metering position, the metering control unit 74 stops the forward rotation and the rearward movement of the screw 28, together with invoking operation of the reverse rotation control unit 76.

After the forward rotation of the screw 28 is stopped, the reverse rotation control unit 76 reversely rotates the screw 28, on the basis of a predetermined reverse rotation condition (hereinafter, also simply referred to as a “reverse rotation condition”). Concerning the reverse rotation of the screw 28, the reverse rotation condition specifies at least one of an angle of rotation (rotation amount), a rotational acceleration, a rotational speed, and a rotation time of the screw 28. The reverse rotation control unit 76 may refer to the reverse rotation condition that is stored in advance in the storage unit 64, or may follow along with a reverse rotation condition that is instructed (specified) by the operator via the operation unit 68.

When the screw 28 is rotated in reverse, the resin on a more rearward side than the check seat 48 is scraped out along the spiral flow path 44 from the check seat 48 toward the side of the hopper 36 in an opposite direction to that at the time of metering. Consequently, the density of the resin on a more rearward side than the check seat 48 decreases, and as a result, the back pressure decreases.

Further, at a point in time when the reverse rotation of the screw 28 is initiated, the check ring 50 is positioned on the side of the screw head 46, and the flow path 44 is open. Accordingly, by the screw 28 continuing to be rotated in reverse, the resin that is accumulated in the metering region passes through the check ring 50, and moves in a rearward direction (flows in reverse) from the frontward direction. More specifically, immediately after metering is completed and the forward rotation of the screw 28 is stopped, due to the influence of viscous resistance of the molten resin, the movement of the resin from the rearward direction toward the frontward direction of the check seat 48 continues for a while. However, after the reverse rotation of the screw 28 is started, accompanying a decrease in the back pressure due to the reverse rotation, it becomes difficult for the resin to move in the frontward direction. Additionally, as the screw 28 continues to reversely rotate, the direction of flow of the resin is reversed, and a reverse flow of the resin from the frontward direction toward the rearward direction of the check seat 48 is initiated.

When the resin flows in reverse from the front to the rear of the check seat 48, since the density of the resin on the front side of the check seat 48 decreases, as a result, the back pressure decreases. Further, since the amount of resin in the metering region decreases, the amount of resin in the metering region, which has adversely become greater than the appropriate amount, can be made to approach the appropriate amount.

In this manner, by causing the resin to flow in reverse, the reverse rotation control unit 76 not only reduces the back pressure, but also can achieve an adjustment in the amount of resin that is accumulated in the metering region.

After the reverse rotation of the screw 28 has started, during a period in which the reverse rotation control unit 76 reversely rotates the screw 28, the judgment unit 78 continuously judges whether or not the back pressure has reached a predetermined rearward movement initiation pressure P2.

The rearward movement initiation pressure P2 is determined in advance, prior to the screw 28 being reversely rotated by the reverse rotation control unit 76, so as to lie within a range of being less than or equal to the metering pressure P1 and more than the target pressure P0 (P1≥P2>P0). In this instance, an ideal rearward movement initiation pressure P2 is the magnitude of the back pressure at the time that the amount of resin in the metering region coincides with an appropriate amount due to the reverse flow of the resin that is generated when the screw 28 is rotated in reverse.

The specific value of the ideal rearward movement initiation pressure P2 varies depending on the reverse rotation condition, and does not necessarily coincide with the metering pressure P1. According to the present embodiment, the ideal rearward movement initiation pressure P2 is easily determined, by the judgment unit 78 referring to a table 82 in which the reverse rotation condition and the ideal rearward movement initiation pressure P2 under the reverse rotation condition are associated with each other.

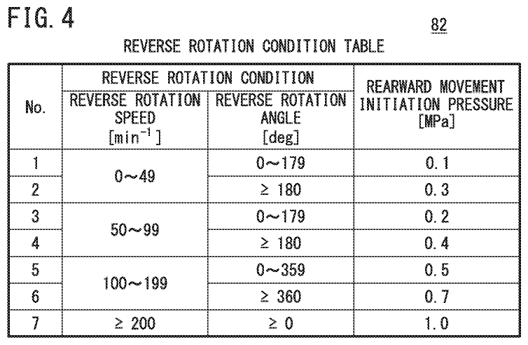

FIG. 4 is an example of the table 82 that is referred to by the judgment unit 78.

For example, the judgment unit 78 refers to the table 82 as shown in FIG. 4. The table 82 can be obtained in advance by experiment, and is stored in the storage unit 64. When the table 82 is created in advance, it is preferable to create a plurality of such tables 82 in accordance with specifications of the injection unit 16 and the type of resin.

In the table 82 of FIG. 4, combinations for each of set values of the reverse rotational speed and the reverse rotation angle of the screw 28 are stored in a “reverse rotation condition” column, and values of the rearward movement initiation pressure P2 corresponding respectively to such combinations are stored in a “rearward movement initiation pressure” column.

When determining the rearward movement initiation pressure P2 by referring to such a table 82, if the reverse rotational speed and the reverse rotation angle, specified by the reverse rotation condition, for example, are respectively 49 min⁻¹ and 179 degrees, the judgment unit 78 determines the rearward movement initiation pressure P2 to be 0.1 MPa. Further, for example, if the reverse rotational speed is 200 min⁻¹, then regardless of the reverse rotation angle, the rearward movement initiation pressure P2 is determined to be 1.0 MPa.

In this manner, the judgment unit 78 determines the ideal rearward movement initiation pressure P2 without the operator performing trial and error attempts. The table 82 is not limited to the example shown in FIG. 4. For example, in the table 82, the rotational acceleration and the rotation time may be associated with the rearward movement initiation pressure P2.

In the case that it is determined by the judgment unit 78 that the back pressure has reached the rearward movement initiation pressure P2, the rearward movement control unit 80 causes the screw 28 to be moved further rearward (sucked back) from the metering position, based on a predetermined rearward movement condition (hereinafter, also simply referred to as a “rearward movement condition”). By causing the screw 28 to be sucked back, the position of the check seat 48 is moved rearward relative to the cylinder 26, and therefore, the volume of the metering region is increased. Consequently, since the pressure imposed on the resin in the metering region is alleviated, the back pressure is reduced.

The rearward movement condition specifies at least one of a rearward movement distance, a rearward movement speed, and a rearward movement time of the screw 28, in relation to sucking back of the screw 28. The rearward movement control unit 80 may refer to the rearward movement condition that is stored in advance in the storage unit 64, or may follow along with a rearward movement condition that is specified by the operator via the operation unit 68.

Sucking back is an operation of the screw 28 that is independent of the rotation of the screw 28. Accordingly, the rearward movement control unit 80 can perform sucking back in an overlapping manner with the reverse rotation of the screw 28 by the reverse rotation control unit 76.

Consequently, a decrease in the back pressure due to the reverse rotation of the screw 28, and a decrease in the back pressure due to sucking back of the screw 28 are performed in parallel. As a result, the back pressure can be more quickly reduced, in comparison with a case in which only one of the reverse rotation and sucking back of the screw 28 is performed, and a case in which these actions are sequentially performed in order, respectively.

By using the reverse rotation and sucking back of the screw 28 in combination, the reverse rotation condition can be specified in a manner so that the act of sucking back primarily plays a role in causing the back pressure to decrease, whereas the reverse rotation primarily plays a role in causing the amount of resin that is excessively accumulated in the metering region to be reduced.

More specifically, by performing sucking back in an overlapping manner during reverse rotation of the screw 28, not only the back pressure can be quickly reduced, but also a situation can be prevented in which the amount of resin in the metering region becomes excessive. Therefore, according to the present embodiment, it is possible to prevent the amount of resin injected into the mold 12 from becoming excessive, and variations in the mass of the manufactured molded products can be reduced. As a result, molding defects such as sink marks and burrs caused by the inappropriate amount of resin can be reduced, and high quality molded products can be stably molded.

In this instance, if the rearward movement initiation pressure P2 is ideally determined, the amount of resin to be injected will be in the vicinity of an appropriate amount or at an amount that coincides with the appropriate amount when the reduction in pressure is completed. Consequently, high quality molded products can be molded. According to the present embodiment, by the judgment unit 78 referring to the table 82 that has been prepared in advance, an ideal rearward movement initiation pressure P2 is easily determined without the operator being made to perform trial and error attempts.

In the foregoing manner, according to the control device 20 of the present embodiment, it is possible to rapidly achieve a reduction in pressure in the injection molding machine 10, and to obtain high quality molded products.

Next, a description will be given concerning the method of controlling the injection molding machine 10 which is performed by the control device 20. As a premise, it is assumed that the metering conditions, the reverse rotation condition, and the rearward movement condition have been stored in the storage unit 64 in advance.

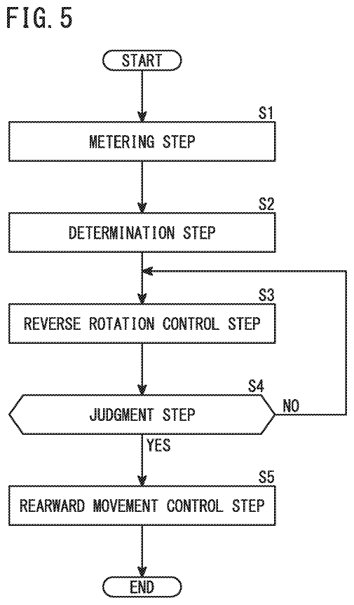

FIG. 5 is a flowchart showing an example of a method of controlling the injection molding machine 10, which is executed by the control device 20 of the embodiment.

First, the control device 20, on the basis of the metering conditions, performs metering of the resin inside the cylinder 26 by controlling the forward rotation and the rearward movement of the screw 28 until the screw 28 is moved rearward to the metering position (step S1: metering step). The metering step continues until the screw 28 reaches the metering position.

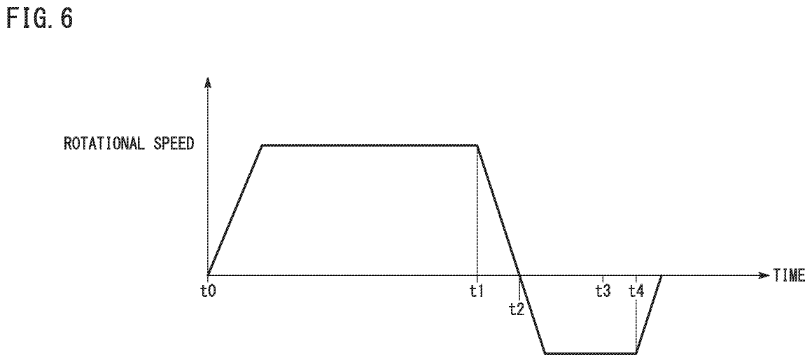

FIGS. 6 to 8 are time charts concerning the rotation speed (of the screw 28), the rearward movement speed (of the screw 28), and the back pressure in the case that the control method of the flowchart of FIG. 5 is performed. Moreover, in each of FIGS. 6 to 8, the vertical axes thereof respectively represent the rotational speed, the rearward movement speed, and the back pressure. Further, the horizontal axis in each of the figures represents time.

Time t0 in FIGS. 6 to 8 indicates a start time t0 of the metering step. Further, time t1 indicates a point in time at which the screw 28 arrives at the metering position.

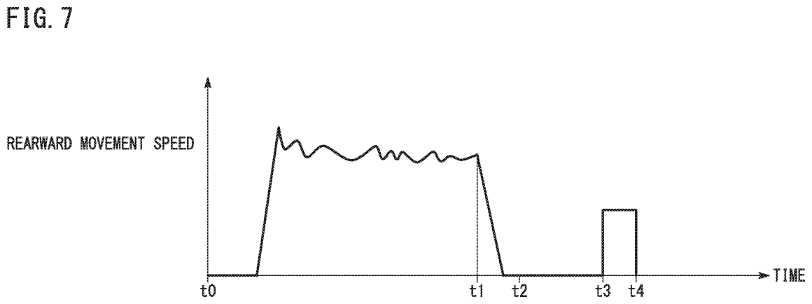

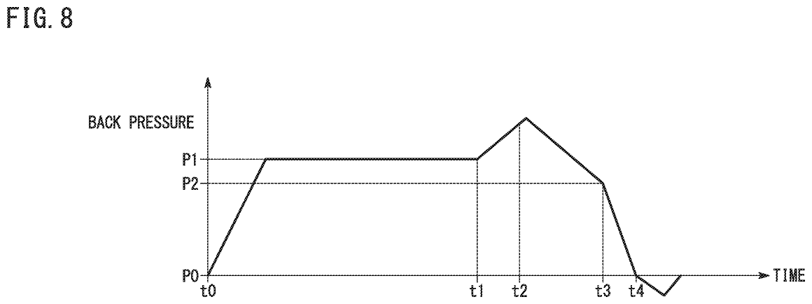

The period from time t0 to time t1 is a time zone in which metering is carried out by the control device 20. As shown in FIG. 6, the rotational speed of the screw 28 starts increasing from the start time t0 of the metering step, and thereafter, reaches a metering rotational speed designated by the metering conditions. Further, as shown in FIG. 8, the back pressure starts increasing after time t0 accompanying the forward rotation of the screw 28, and thereafter, reaches the metering pressure P1 designated by the metering conditions. As shown in FIG. 7, the rearward movement speed of the screw 28 is controlled so as to start increasing when the back pressure comes in close proximity to the metering pressure P1 after the metering step has started, and so that the back pressure becomes the metering pressure P1.

Time t1 and thereafter is a time zone in which the control device 20 carries out a reduction in pressure. When time t1 is reached, the control device 20 determines the rearward movement initiation pressure P2 (step S2: determination step) by referring to the table 82 in which the reverse rotation condition and the rearward movement initiation pressure P2 are associated with each other. The rearward movement initiation pressure P2 that was determined is stored in the storage unit 64.

Next, the control device 20 reversely rotates the screw 28 based on the reverse rotation condition while monitoring the back pressure (step S3: reverse rotation control step).

Time t2 in FIGS. 6 to 8 indicates a point in time when the reverse rotation of the screw 28 is started. Moreover, in order to facilitate description, stopping of the forward rotation of the screw 28 takes place at the same time as time t2.

As can be understood from FIGS. 6 and 7, the rotational speed and the rearward movement speed of the screw 28 are rapidly decreased to zero after time t1. During this period, as shown in FIG. 8, the back pressure continues to increase until reaching time t2. Such a feature takes place because, as already explained previously, the resin is continuously fed and compressed. As a result, an amount of resin in excess of an appropriate amount becomes accumulated in a location on the front side (metering region) of the check seat 48.

The back pressure begins to decrease after time t2 when the reverse rotation of the screw 28 is started. When the screw 28 is rotated in reverse, a reverse flow of the resin gradually occurs inside the cylinder 26, and after such a reverse flow has occurred, the amount of resin in the metering region approaches the appropriate amount.

Next, after the reverse rotation of the screw 28 has started, the control device 20 judges whether or not the back pressure has reached the rearward movement initiation pressure P2 (step S4: judgment step).

The judgment step is continuously performed during execution of the reverse rotation control step. If the back pressure has reached the rearward movement initiation pressure P2 (YES), the control device 20 initiates the subsequent rearward movement control step. However, if the back pressure has not reached the rearward movement initiation pressure P2 (NO), the reverse rotation control step is continued.

In the case it is judged in the judgment step that the back pressure has reached the rearward movement initiation pressure P2, the control device 20 carries out rearward-movement (sucking back) of the screw 28 based on the predetermined rearward movement condition (step S5: rearward movement control step). Consequently, the volume of the metering region is increased together with the density of the resin being reduced, and therefore, the back pressure decreases.

In FIGS. 6 to 8, time t3 indicates a point in time at which the back pressure has reached the rearward movement initiation pressure P2. Further, time t4 indicates a point in time (a point in time when the reduction in pressure is completed) at which the back pressure reaches the target pressure P0.

During the period from time t3 to time t4, sucking back of the screw 28 is performed in an overlapping manner with the reverse rotation of the screw 28. During the period from time t3 to time t4, due to being sucked back in this manner, since the check seat 48 itself is moved rearward relative to the cylinder 26, the reverse flow of the resin from the metering region to a rearward side beyond the check seat 48 due to the reverse rotation of the screw 28 is prevented. Consequently, the amount of resin adjusted in the reverse rotation control step is maintained from time t3 and thereafter.

However, even if the reverse flow of the resin from the front side to the rear side of the check seat 48 is suppressed, the resin on the rear side of the check seat 48 continues to flow in reverse due to the reverse rotation of the screw 28. Therefore, even in the period from time t3 to time t4, the back pressure continues to decrease due to the reverse rotation of the screw 28.

As a result, in the period from time t3 to time t4, the decrease in back pressure due to sucking back of the screw 28 and the decrease in back pressure due to reverse rotation of the screw 28 take place in parallel, and therefore, the back pressure rapidly decreases toward the target pressure P0. The rearward movement control step comes to an end when the back pressure falls to the target pressure P0 (END).

The above description is offered as one example of the control device 20 and the control method according to the present embodiment. However, as will be exemplified below, it should be noted that the control device 20 and the control method of the present embodiment are not limited to the features described above.

In the event that the metering can be performed by another device, the control device 20 need not necessarily comprise the metering control unit 74. In this case, the control device 20 may be started up upon completion of the metering. In this regard, the control device 20 may also include constituent elements in order to control injection and mold opening within the molding cycle.

The device or apparatus to which the control device 20 can be applied is not limited to an in-line injection molding machine (the injection molding machine 10). The control device 20 may be applied to a preplasticating type injection molding machine (a screw preplasticating type injection molding machine) which is equipped with a screw.

The configurations of the first drive device 32 and the second drive device 34 are not limited to the configurations described above. For example, instead of the servomotor 52a and the servomotor 52b, at least one of the first drive device 32 and the second drive device 34 may include a hydraulic cylinder or a hydraulic motor.

### MODIFICATIONS

Although an embodiment has been described above as one example of the present invention, it goes without saying that various modifications or improvements are capable of being added to the above-described embodiment. It is clear from the scope of the claims that other modes to which such modifications or improvements have been added can be included within the technical scope of the present invention.

### Modification 1

According to the embodiment, the reverse rotation of the screw 28 continues until time t4 when the back pressure has decreased to the target pressure P0, however the reverse rotation of the screw 28 may be stopped between time t3 and time t4. In that case, the reverse rotation condition may be specified in a manner so that the reverse rotation of the screw 28 is stopped between time t3 and time t4.

From time t3 until the reverse rotation of the screw 28 is stopped, the reverse rotation and sucking back of the screw 28 are performed in an overlapping manner (i.e., in a concurrent manner). Accordingly, the reduction in pressure is achieved more quickly than in a case in which the reverse rotation of the screw 28 and sucking back of the screw are not performed in an overlapping manner.

Further, after the reverse rotation of the screw 28 has been stopped, the reverse flow of the resin in the rearward direction from the metering region is further suppressed in comparison with the embodiment.

### Modification 2

In the case that the back pressure has not decreased to the rearward movement initiation pressure P2 by a predetermined timing, the rearward movement control unit 80 may cause the screw 28 to be moved rearward (sucked back) on the basis of the rearward movement condition regardless of the judgment made by the judgment unit 78.

Stated otherwise, in the case that the back pressure has not decreased to the rearward movement initiation pressure P2 by the predetermined timing in the reverse rotation control step, the rearward movement control step may be started regardless of the judgment made in the judgment step.

In accordance with this feature, even in the case that the decrease of the back pressure by the reverse rotation of the screw 28 cannot be successfully performed due to some reason, sucking back of the screw 28 can be started at the above-described timing to thereby reduce the back pressure. As “some reason”, various cases can be considered in which the injection molding machine 10 is operated, and there may be cited, for example, an abnormality of the first drive device 32, or a command of an inappropriate reverse rotation condition due to an erroneous operation by the operator.

The above-described timing, for example, is a time at which the reverse rotation of the screw 28 based on the reverse rotation condition is completed. The reverse rotation of the screw 28 may be completed prior to the back pressure having decreased to the rearward movement initiation pressure P2, in accordance with the specifications of the rotation amount and the rotation time of the reverse rotation in the reverse rotation condition. According to the present modification, the back pressure can be decreased by sucking back the screw 28, even after the reverse rotation of the screw 28 has ended prior to the back pressure being reduced to the rearward movement initiation pressure P2.

### Modification 3

In relation to Modification 2, the control device 20 may further be equipped with a notification unit 84 that issues a notification to such an effect in the case that the reverse rotation of the screw 28 has been completed before the rearward movement control unit 80 causes the screw 28 to be moved rearward. In accordance with this feature, the operator can be prompted to review the reverse rotation condition, and appropriate operation of the injection molding machine 10 thereafter can be promoted.

The notification unit 84, although not particularly limited to such features, includes, for example, a speaker that emits sound, and a lamp (notification lamp) that emits light. Further, the notification unit 84 may also include the display unit 66 that was described in the embodiment. The notification format of the notification unit 84 having the display unit 66 may be, for example, a format in which predetermined icons or messages are displayed on the display unit 66.

### Modification 4

The method of determining the rearward movement initiation pressure P2 is not limited to referring to the table 82. In the determination step, the rearward movement initiation pressure P2 may be determined by being specified by the operator via the operation unit 68.

Further, after the rearward movement initiation pressure P2 has been determined by referring to the table 82, by the operator operating the operation unit 68, the value of the rearward movement initiation pressure P2 may be adjusted. In this case as well, it is preferable for the operator to confirm whether or not the product quality of the molded product lies within an allowable range permitted by the product itself.

During operation of the injection molding machine 10, there may be cases in which the operator considers reducing the back pressure more rapidly, by lengthening the time period during which the reverse rotation and sucking back of the screw 28 are performed in an overlapping manner. According to the present modification, it is possible to enable convenience in relation to such an intention of the operator.

### Modification 5

The above-described embodiments and the modifications thereof may be appropriately combined within a range in which no technical inconsistencies occur.

### Inventions that can be Obtained from the Embodiment

The inventions that can be grasped from the above-described embodiment and the modifications thereof will be described below.

### First Invention

The control device (20) for the injection molding machine (10) includes the cylinder (26) into which the resin is supplied, and the screw (28) that moves forward and rearward and rotates inside the cylinder (26), the injection molding machine being configured to perform a metering of the resin while the resin is being melted inside the cylinder (26), by causing the screw (28) to be moved rearward to the predetermined metering position while being forwardly rotated, the control device including the pressure acquisition unit (72) that acquires the pressure of the resin inside the cylinder (26), the reverse rotation control unit (76) which causes the screw (28) to be rotated in reverse based on the predetermined reverse rotation condition so as to reduce the pressure of the resin, after the screw (28) has been moved rearward to the predetermined metering position, the judgment unit (78) that judges whether or not the pressure of the resin has reached the predetermined rearward movement initiation pressure (P2), after the reverse rotation of the screw (28) is started, and the rearward movement control unit (80) which causes the screw (28) to be moved rearward based on the predetermined rearward movement condition, in the case that the judgment unit (78) judges that the pressure of the resin has reached the rearward movement initiation pressure (P2).

In accordance with such features, the control device (20) for the injection molding machine (10) is provided, which is capable of quickly achieving a reduction in pressure, and in which high quality molded products can be obtained.

The predetermined reverse rotation condition may specify at least one of a rotation amount, a rotational acceleration, a rotational speed, and a rotation time of the screw (28). In accordance with this feature, the pressure of the resin (back pressure) can be reduced due to the reverse rotation of the screw (28).

The predetermined rearward movement condition may specify at least one of a rearward movement distance, a rearward movement speed, and a rearward movement time of the screw (28). In accordance with this feature, the pressure of the resin can be reduced due to the rearward movement (retraction) of the screw (28).

There may further be provided the operation unit (68) through which an operator specifies the rearward movement initiation pressure (P2). In accordance with this feature, the reverse rotation and sucking back of the screw (28) can be performed in an overlapping manner after the pressure of the resin has reached the specified rearward movement initiation pressure (P2).

The judgment unit (78) may determine the rearward movement initiation pressure (P2) by referring to the table (82) in which the predetermined reverse rotation condition and the rearward movement initiation pressure (P2) are associated with each other. In accordance with this feature, an ideal rearward movement initiation pressure (P2) can be determined without the operator performing trial and error attempts.

In the case that the pressure of the resin has not decreased to the rearward movement initiation pressure (P2) by the predetermined timing, the rearward movement control unit (80) may cause the screw (28) to be moved rearward on the basis of the rearward movement condition regardless of the judgment made by the judgment unit (78). In accordance with this feature, even in the case that the decrease of the pressure of the resin by the reverse rotation of the screw (28) cannot be successfully performed due to some reason, sucking back of the screw (28) can be started at the above-described timing to thereby reduce the pressure of the resin.

The aforementioned timing may be a time when the reverse rotation of the screw (28) based on the predetermined reverse rotation condition is completed. With this configuration, the pressure of the resin can be decreased by sucking back the screw (28), even after the reverse rotation of the screw (28) has ended prior to the pressure of the resin being reduced to the rearward movement initiation pressure (P2).

### Second Invention

In the method of controlling the injection molding machine (10) including the cylinder (26) into which the resin is supplied, and the screw (28) configured to move forward and rearward and rotate inside the cylinder (26), the injection molding machine being configured to perform a metering of the resin while the resin is being melted inside the cylinder (26), by causing the screw (28) to be moved rearward to the predetermined metering position while being forwardly rotated, the method includes the reverse rotation control step of causing the screw (28) to be rotated in reverse based on the predetermined reverse rotation condition so as to reduce the pressure of the resin, while monitoring the pressure of the resin inside the cylinder (26), after the screw (28) has been moved rearward to the predetermined metering position, the judgment step of judging whether or not the pressure of the resin has reached the predetermined rearward movement initiation pressure (P2), after the reverse rotation of the screw (28) is started, and the rearward movement control step of moving the screw (28) rearward based on the predetermined rearward movement condition and rotating the screw (28) in reverse, so as to reduce the pressure of the resin, in the case it is judged in the judgment step that the pressure of the resin has reached the rearward movement initiation pressure (P2).

In accordance with such features, the control method for the injection molding machine (10) is provided, which is capable of quickly achieving a reduction in pressure, and in which high quality molded products can be obtained.

The predetermined reverse rotation condition may specify at least one of a rotation amount, a rotational acceleration, a rotational speed, and a rotation time of the screw (28). In accordance with this feature, the pressure of the resin (back pressure) can be reduced due to the reverse rotation of the screw (28).

The predetermined rearward movement condition may specify at least one of a rearward movement distance, a rearward movement speed, and a rearward movement time of the screw (28). In accordance with this feature, the pressure of the resin can be reduced due to the rearward movement (retraction) of the screw (28).

There may further be included the determination step of determining, prior to the reverse rotation control step, the rearward movement initiation pressure (P2) based on an instruction from the operator. In accordance with this feature, the reverse rotation and sucking back of the screw (28) can be performed in an overlapping manner after the pressure of the resin has reached the instructed rearward movement initiation pressure (P2).

There may further be included the determination step of determining, prior to the reverse rotation control step, the rearward movement initiation pressure (P2) by referring to the table (82) in which the predetermined reverse rotation condition and the rearward movement initiation pressure (P2) are associated with each other. In accordance with this feature, an ideal rearward movement initiation pressure (P2) can be determined without the operator performing trial and error attempts.

In the case that the pressure of the resin has not decreased to the rearward movement initiation pressure (P2) by the predetermined timing in the reverse rotation control step, the rearward movement control step may be initiated regardless of the judgment made in the judgment step. In accordance with this feature, even in the case that the decrease of the pressure of the resin by the reverse rotation of the screw (28) cannot be successfully performed due to some reason, sucking back of the screw (28) can be started at the above-described timing to thereby reduce the pressure of the resin.

The aforementioned timing may be a time when the reverse rotation of the screw (28) based on the predetermined reverse rotation condition is completed. According to the present modification, the pressure of the resin can be decreased by sucking back the screw (28), even after the reverse rotation of the screw (28) has ended prior to the pressure of the resin being reduced to the rearward movement initiation pressure (P2).

What is claimed is:

1. A control device for an injection molding machine including a cylinder into which a resin is supplied, and a screw configured to move forward and rearward and rotate inside the cylinder, the injection molding machine being configured to perform a metering of the resin while the resin is being melted inside the cylinder, by causing the screw to be moved rearward to a predetermined metering position while being forwardly rotated, the control device comprising:
a pressure acquisition unit configured to acquire a pressure of the resin inside the cylinder;
a reverse rotation control unit configured to cause the screw to be rotated in reverse based on a predetermined reverse rotation condition so as to reduce the pressure of the resin, after the screw has been moved rearward to the predetermined metering position;
a judgment unit configured to judge whether or not the pressure of the resin has reached a predetermined rearward movement initiation pressure, after the reverse rotation of the screw is started; and
a rearward movement control unit configured to cause the screw to be moved rearward based on a predetermined rearward movement condition, in a case that the judgment unit judges that the pressure of the resin has reached the rearward movement initiation pressure.

2. The control device for the injection molding machine according to claim 1, wherein the predetermined reverse rotation condition specifies at least one of a rotation amount, a rotational acceleration, a rotational speed, and a rotation time of the screw.

3. The control device for the injection molding machine according to claim 1, wherein the predetermined rearward movement condition specifies at least one of a rearward movement distance, a rearward movement speed, and a rearward movement time of the screw.

4. The control device for the injection molding machine according to claim 1, further comprising an operation unit through which an operator specifies the rearward movement initiation pressure.

5. The control device for the injection molding machine according to claim 1, wherein the judgment unit determines the rearward movement initiation pressure by referring to a table in which the predetermined reverse rotation condition and the rearward movement initiation pressure are associated with each other.

6. The control device for the injection molding machine according to claim 1, wherein, in a case that the pressure of the resin has not decreased to the rearward movement initiation pressure by a predetermined timing, the rearward movement control unit causes the screw to be moved rearward based on the rearward movement condition regardless of a judgment made by the judgment unit.

7. The control device for the injection molding machine according to claim 6, wherein the timing is a time when the reverse rotation of the screw based on the predetermined reverse rotation condition is completed.

8. A method of controlling an injection molding machine including a cylinder into which a resin is supplied, and a screw configured to move forward and rearward and rotate inside the cylinder, the injection molding machine being configured to perform a metering of the resin while the resin is being melted inside the cylinder, by causing the screw to be moved rearward to a predetermined metering position while being forwardly rotated, the method comprising:
a reverse rotation control step of causing the screw to be rotated in reverse based on a predetermined reverse rotation condition so as to reduce a pressure of the resin, while monitoring the pressure of the resin inside the cylinder, after the screw has been moved rearward to the predetermined metering position;
a judgment step of judging whether or not the pressure of the resin has reached a predetermined rearward movement initiation pressure, after the reverse rotation of the screw is started; and
a rearward movement control step of moving the screw rearward based on a predetermined rearward movement condition and rotating the screw in reverse, so as to reduce the pressure of the resin, in a case that it is judged in the judgment step that the pressure of the resin has reached the rearward movement initiation pressure.

9. The method of controlling the injection molding machine according to claim 8, wherein the predetermined reverse rotation condition specifies at least one of a rotation amount, a rotational acceleration, a rotational speed, and a rotation time of the screw.

10. The method of controlling the injection molding machine according to claim 8, wherein the predetermined rearward movement condition specifies at least one of a rearward movement distance, a rearward movement speed, and a rearward movement time of the screw.

11. The method of controlling the injection molding machine according to claim 8, further comprising a determination step of determining, prior to the reverse rotation control step, the rearward movement initiation pressure based on an instruction from an operator.

12. The method of controlling the injection molding machine according to claim 8, further comprising a determination step of determining, prior to the reverse rotation control step, the rearward movement initiation pressure by referring to a table in which the predetermined reverse rotation condition and the rearward movement initiation pressure are associated with each other.

13. The method of controlling the injection molding machine according to claim 8, wherein the rearward movement control step is initiated, regardless of a judgment made in the judgment step, in a case that the pressure of the resin has not decreased to the rearward movement initiation pressure by a predetermined timing in the reverse rotation control step.

14. The method of controlling the injection molding machine according to claim 13, wherein the timing is a time when the reverse rotation of the screw based on the predetermined reverse rotation condition is completed.
